(19) United States
(12) Patent Application Publication
(10) Pub. No.: US 2014/0092241 A1
(43) Pub. Date: Apr. 3, 2014

(54) DEVICE AND METHOD FOR SCANNING OF BOOKS AND OTHER ITEMS FOR ORDER AND INVENTORY CONTROL

(71) Applicant: Miami University, Oxford, OH (US)

(72) Inventors: William Brinkman, Oxford, OH (US); Matthew Hodges, Cincinnati, OH (US)

(21) Appl. No.: 14/043,154

(22) Filed: Oct. 1, 2013

Related U.S. Application Data
(60) Provisional application No. 61/708,225, filed on Oct. 1, 2012.

(51) Int. Cl. G06K 9/00

(52) U.S. Cl. CPC G06K 9/00671
USPC 348/135; 382/103

(57) ABSTRACT

A method and device for creating digital optical images of bindings of books or other items in order to determine whether the books are in the correct order, such as on a bookshelf. The digital images are analyzed by a computer to determine whether the unique identifier of the book indicates the books is out of order relative to one or more next adjacent books bearing unique identifiers. If a book is out of order, an augmented reality image is produced with the digital image on the display of the device to indicate which books is out of order, and which books are in order. The user of the system can correct the disorder and re-scan to confirm order. The system also retains information about which books were scanned, which books were adjacent each scanned book, and whether the books were in or out of order.

### BACKGROUND OF THE INVENTION

This invention relates generally to the organizing of books on library and other bookshelves, and more particularly to a means for detecting whether books or other items are out of order and indicating how to re-order any books or other items that are out of order.

One of the most important tasks in a library is keeping the books in order by call number. A book that is misfiled can be considered useless, because it is lost. Library workers must periodically look at every book in the library, one at a time, to make sure the books are in their correct location. This process is time-consuming and tedious, and because humans tend to be poor at the task of reviewing every book, errors occur.

“Shelf Reading” is the process of checking books on a bookshelf to make sure they are in the correct order. The process of shelf-reading in a library is a sorting task, but with keys that are fairly complicated. In academic libraries, for example, the Library of Congress call numbers (LC numbers) are used for organizing books. Because the call numbers are long and complicated, and often break across lines, it is easy for library workers to make mistakes.

“Inventory” is the process of making a list of all books currently on the shelves of a library or other book depository. The processes for shelf reading and inventory conventionally require a human to process books one at a time. Because humans tend to be poor at searching, sorting, and remembering abstract numerical data, errors can occur in these processes.

At its best, technology assists humans by automating tasks that they naturally do poorly, and highlighting what they naturally do well. Humans tend to be good at reasoning, visual processing and spatial processing and planning. Humans are poor at shelf-reading in a library, because this task is monotonous and tedious, and it is easy to fail to notice that numbers are out of order, especially if the person carrying out the task is tired or distracted. For most libraries, however, shelf-reading is the main method of inventory control.

There are existing technologies that use a unique radio frequency identification (RFID) device attached to every book. The system uses a scanner that is passed in close proximity to the books' RFID tags in series, and the tags are “read” (i.e., scanned in order) one at a time to detect whether the tags are in the correct order. While it is possible to use RFID systems, the tags and scanning devices are expensive and scanning is time-consuming because the librarian must scan books in series along every shelf.

“Augmented Reality” is when real objects and virtual objects appear to share the same space. A common example of augmented reality is seen during a televised football game when the television producer displays a line across the field of play that represents a “first down” line that does not actually exist on the field. Effective augmented reality applications harness computers' abilities to handle a lot of data and present information to human senses to take advantage of the visual and spatial processing at which humans are inherently skilled.

The need exists for a new technology that utilizes inherent human strengths, technological strengths and does so without significant costs that libraries and other facilities do not have.

### BRIEF SUMMARY OF THE INVENTION

A device and method have been developed for optically scanning bookshelves for a unique identifier on the binding of each book, processing information about the order of the books on a shelf based on the unique identifiers, and presenting augmented reality instructions for a human user to indicate how he or she should re-order any books that are out of order. The device and method can be used on any objects that are organized to have a particular order, and are not limited to use with books in a library.

In a preferred embodiment, an augmented reality smartphone application is used to semi-automate the shelf reading process. Furthermore, inventory control reports are produced. Instead of requiring specialized hardware or other equipment, the device includes materials that many library staff and patrons already have access to: paper labels and smart phones. This embodiment uses simple black and white labels with boxy codes that correspond to the books' LC call numbers that are affixed to the spine of each book. The smartphone is used to scan multiple labels simultaneously to “read” multiple books at the same time, and entire bookshelves in seconds. The smartphone then displays on the screen, along with digital images of the books, an indicator of which books are out of order or missing, and possibly how best to move the books to put them back in order. The application also generates reports based on what books were detected in each shelf reading session, thus producing inventory and internal use statistics for library staff to evaluate.

The invention is preferably an augmented reality system for Android, iOS and other operating system smart phones that reduces time spent on manual shelf reading. Accuracy is also increased, and the library simultaneously obtains an inventory of the books on the shelves.

### BRIEF DESCRIPTION OF THE SEVERAL VIEWS OF THE DRAWINGS

FIG. 1 is a view in perspective illustrating a plurality of books on bookshelves in a conventional, side-by-side configuration with their spines facing outward.

FIG. 2 is a schematic view illustrating a bookshelf and a smartphone in close proximity thereto scanning the books on the shelf.

FIG. 3 is a rear view illustrating a conventional smartphone.

FIG. 4 is a schematic view illustrating an image displayed on the display screen of the smartphone and illustrating the image of the bookshelf with the augmented reality images displayed thereupon indicating that at least one book needs to be moved to another location.

FIG. 5 is a schematic view illustrating an image displayed on the display screen of the smartphone and illustrating the image of the bookshelf with the augmented reality images displayed thereupon indicating that all books are in the correct order.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application No. 61/708,225 filed Oct. 1, 2012 is incorporated in this application by reference.

There are many applications for use of the devices and methods described herein. The devices and methods are useful in any situation in which multiple objects are organized in physical space in a particular order. Thus, the invention will work with books in a library's bookshelves, inventory on a retail store's shelves and cases, inventory in a warehouse's storage units, inventory on an automobile repair facility's shelves, and countless other situations that, from the description herein, will become apparent to a person of ordinary skill Furthermore, when an item is not in the correct order, an indicator is provided that is human-perceptible. Such an indicator can be visible, audible, tactile or otherwise available to the senses of the user of the device and method. Although the preferred visually perceptible indicator is described below, the person having ordinary skill will be aware of how to adapt the preferred indicator to other circumstances without departing from the spirit of the invention.

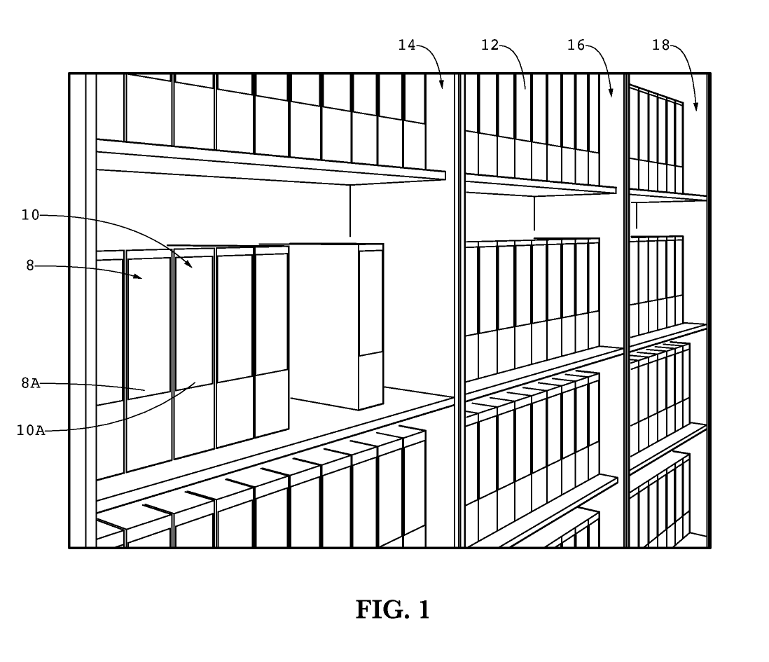

One contemplated use of the method and device is in maintaining the order of books on the bookshelves of a library. In such a situation, as described above, the books 8, 10 and 12 are on bookshelves 14, 16 and 18 in a conventional configuration as shown in FIG. 1. In the conventional bookshelf configuration of FIG. 1, planes containing the books 8, 10 and 12 are substantially parallel to one another such that the spines 8a and 10a of the books 8 and 10 are aligned with one another and presented to someone facing the spines of the books on the bookshelves. This is the standard presentation of books in a library, and is known to those familiar with the art. However, any presentation that allows optical scanning of the relevant portions of the books can be substituted for that shown in FIG. 1.

A preferred device for use with the method is a smartphone, such as an IPHONE brand phone, a GALAXY brand phone or any conventional similar device. It is also contemplated that a special-purpose device can be constructed to carry out some or all of the steps, and such a device would be required to have at least a camera, a display for showing the digital images taken by the camera and a computer for operating the software that carries out the method. Preferably the device would have a light for illuminating books in poor light, and would also have a connection to a system that retains data as described below. This connection could be wired or wireless, and is preferably a conventional Wi-Fi, Bluetooth or any other suitable protocol connection.

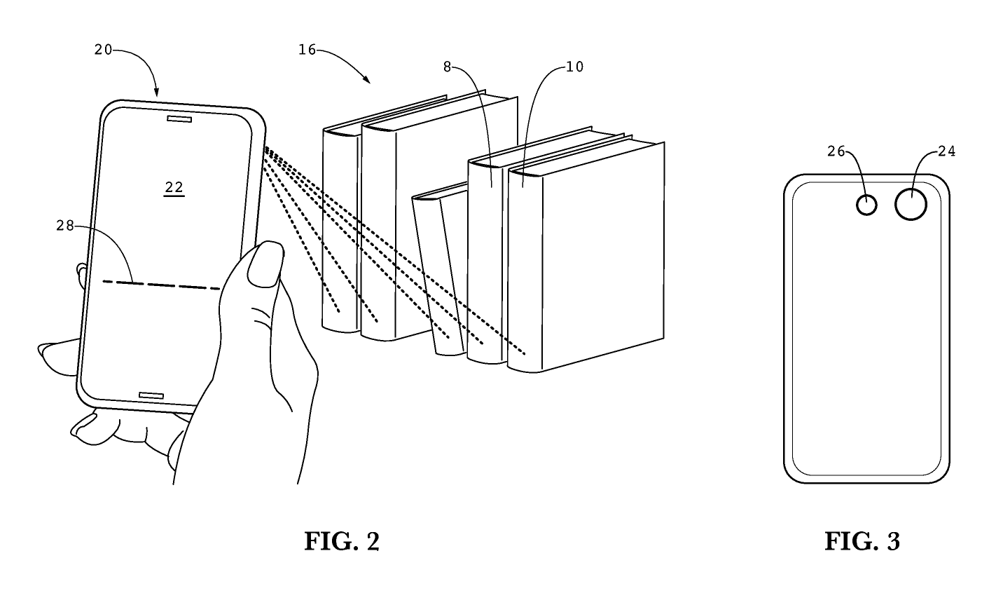

The preferred device uses a software application (“app”) loaded onto the smartphone 20 (see FIGS. 2 and 3) that is designed for use with the method described herein. The smartphone has a display 22 that is a conventional liquid crystal display (LCD) or other suitable screen known to be visually perceptible by humans. Preferably on the opposite side of the smartphone 20 there is a camera lens 24 and light 26. The smartphone operates in a conventional manner to collect digital images using the camera lens 24 and display the same substantially simultaneously on the display 22, possibly as illuminated using the light 26. The app that is loaded on the smartphone 20 operates with the hardware of the smartphone to provide additional functionality that will now be explained.

The app is started on the smartphone 20 and a login screen is desirably the first to load in order to ensure security and authorization to use the app. After the user logs in using conventional security measures, the app displays on the display 22 in a conventional manner images captured by the camera lens 24. In a preferred embodiment, an augmented reality horizontal line 28 is placed across the display to assist the user in aligning the camera lens in the preferred position for the automatic focus function of the smartphone. The user thus positions the smartphone 20 to aim the camera lens toward the books 8 and 10 on the bookshelf 16 in order to align the line 28 with the bindings of the books as shown in FIG. 2. The smartphone 20 is positioned a suitable distance from the spines of the books 8 and 10 to obtain digital images through the camera lens 24 that are approximately the entire width of the bookshelf 16 or less than the entire width, and is desirably held at a distance of about 12 to 24 inches with bookshelves of about three feet in width using a conventional smartphone. Typically, a portion of the shelf will be visible in the display 22 at this distance, and the user will scan the smartphone 20 side-to-side during use as described below. The user can use the light 26 on the smartphone, manually or automatically by the app turning the light on when it senses low light.

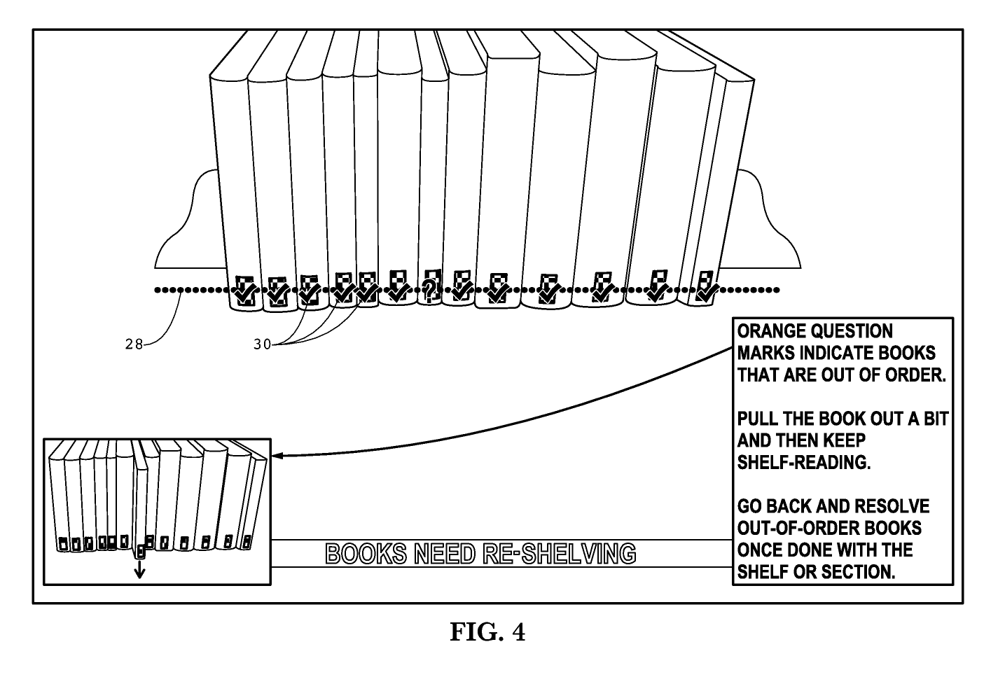

In the preferred embodiment, a plurality of labels 30 bearing unique indicia (also called “tags” herein) are mounted to the spines of the books as shown in FIG. 4. These labels contain the indicia or tags that are processed by the computer of the smartphone, as programmed by the app, when the line 28 is positioned on the indicia of the labels 30. Thus, each book thereby has a unique identifier on its spine that preferably relates to a Library of Congress or other code that is unique for every book ever produced.

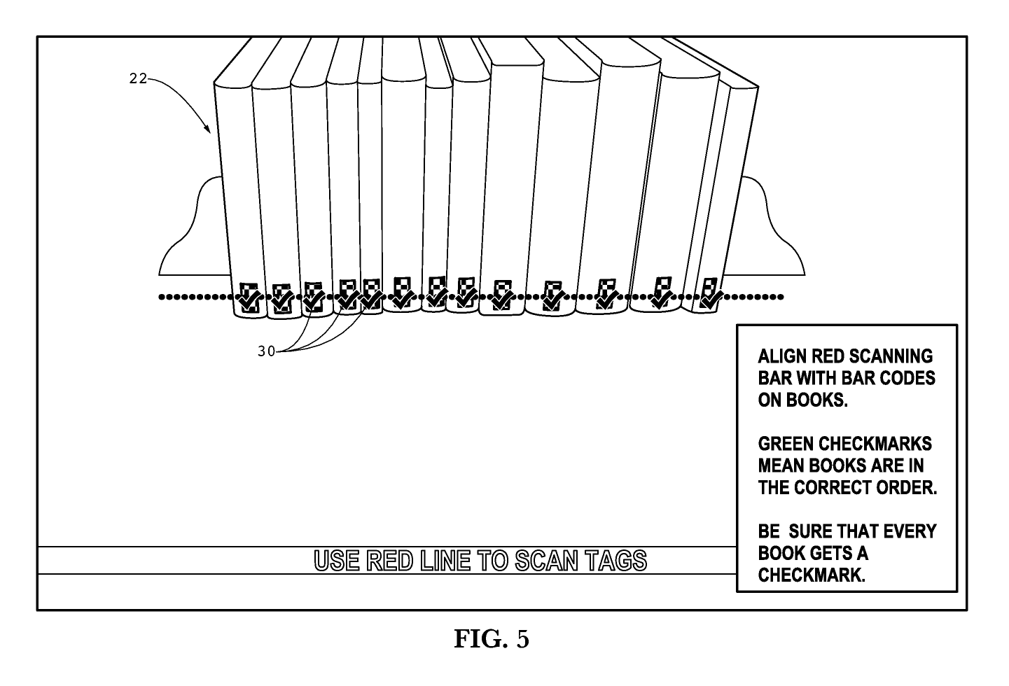

In use, the app uses optical character recognition to calculate whether the books are in the correct order, as determined by the indicia on the labels 30 and their correct (or incorrect) sequence as recognized by the app. If the books are all in the correct order, an indicator, such as a green check mark, is presented on the screen in each book's label space. Thus, as shown in FIG. 5, the labels 30 have the appearance of being covered by a green checkmark that indicates to the user that every book is in the correct order relative to the other books in the display 22.

The green check marks in the display image shown in FIG. 5 are projected onto the screen of the display 22, and do not exist in real space. That is, the check marks are a use of augmented reality to communicate to the human user of the method and device that the books are correctly ordered. Alternative indicators can be used in place of the green check marks, and the green check marks or other indicators can be positioned in a place other than the labels 30, as will be understood by the person having ordinary skill from the description herein. For example, a “thumbs up” image, a yellow circle or any other indicia that is suitable can be used as the indicator that the books are in the correct order. Furthermore, other indicators are considered substitutes in some circumstances, such as audible sounds when a hearing-impaired user is operating the device. The person of ordinary skill will recognize that other sensory indicators are possible and contemplated.

As the user scans the smartphone 20 from side to side, the camera lens 24 receives images of the books on the bookshelf 16 (and then books in other bookshelves), just as is common for smartphone cameras operating in video mode. The indicators representing whether a book is in or out of order are presented to the user on the display 22, preferably for each of the books in the field of view of the display 22, but also possibly less than all the books in the field of view. This presentation of augmented reality indicators occurs in real time as the computer of the smartphone determines the order of the books in digital images received by the camera lens 24 and processed by the optical character recognition software. The user perceives, on the display 22, images of books with augmented reality indicators showing the order of the books. As the user scans the camera across the spines of the remaining books on the shelf, new indicators are presented and appear to remain on the spines of the books as long as the spines are visible on the display 22. Thus, the app presents indicators for every book having a spine image that was successfully analyzed by the smartphone.

The user moves the smartphone left to right fairly rapidly, and begins to see green check marks on the bindings of books that are in the correct order. When the user comes to a book that is out of order, a different indicator, such as a red or orange X or a question mark (“?”), appears on the binding of the disordered book(s). This is shown in FIG. 4. The computer processing occurs simultaneously with viewing through display of phone, so that as the user scans the books with the smartphone 20, the indicators display which books are in order and which are not. Thus, it appears that as the books move from one side of the display 22 to the other, the indicators follow the books to which they relate.

The indicators preferably are presented on the books' spines as the camera scans, so as the screen displays books moving side-to-side, the indicator “follows” the books so indicated. The user will typically scan from left to right on one complete shelf, then down to the next shelf and then left to right on the next shelf down. However, the user can scan left to right, down to the next shelf, and then scan right to left. The method preferably compares books adjacent to one another, so the lateral or horizontal direction of scanning does not impact how that comparison is carried out. The app processes each book's unique tag and compares it to the tag on the left and/or the tag on the right. If the order of the compared tags is correct, a positive order indicator is presented on the display 22 on the spine of the book. The order of the tags is predetermined, and for a library the order is ascending from left to right and from the top to the bottom of a library bookshelf. However, these can be modified for circumstances other than a library.

The app preferably computes the minimum amount of work necessary for the user to reorder (i.e., correctly organize) the books. For example, if one book is twenty spaces to the right of its correct space, the app determines this rather than indicating that 20 books are out of order. That is, the app is programmed to calculate the least number of moves required to put the books in order. An augmented reality arrow could be presented on the display to show the user where the book should be moved to, but this is not required.

As the books are scanned by the user, the code of each book is stored by the app to create an inventory of scanned books. The app thus records the tag of each book scanned, and it also stores data indicating which book is to the left of the scanned book, and which book is to the right of the scanned book. These data are preferably saved automatically, and preferably whenever the smartphone has a wireless connection the data are saved on a central computer that is remote from the smartphone 20 using a conventional protocol. This allows one to later reconstruct the actual order of the books on the shelves, if a user missed an indicator to move a book that the user did not move, and it also constructs a database indicating when every scanned book was last detected and where. This enables one to find lost books very quickly, because one can simply scan the database and the last place the book was located when it was scanned will be indicated by the adjacent books.

Returning to the typical use, once a book is identified as out of order, the library worker will physically move the book to the correct position on the shelf or another shelf, and then preferably scans the shelf again to confirm accuracy. The most recent scan replaces the data previously scanned for the shelf, so that if the books that were recorded as out of order are not out of order during the second scan, there will be no record of the out of order book being out of order when the data uploads to the central computer.

The app's programming includes instructions to upload data to the central computer when there appears to be processor capability and bandwidth over the wireless connection, and the data don't have to be manually uploaded. Therefore, during the brief pause in scanning when the user moves from one shelf to another, the computer recognizes suitable conditions to upload data and it does so in order to prevent a backlog of data that is uploaded at the end of the day. Of course, if a data connection is only available at one time, the data are uploaded at that time.

In general, when scanning books in a library, a goal is to decode approximately 70 to 100 tags (with one tag per book) per frame of video, on a mobile device at an interactive frame rate. One solution involves tagging the spine of each book with a three-eighths inch tag that encodes the book's Library of Congress (LC) call number. The preferred tags directly encode the LC call number, so that Internet access is not required for the system to work. The system gathers the inventory information and stores it locally on the phone. When there is an Internet or other wireless connection, that inventory data is uploaded to the central computer.

The above goal introduces two major technical constraints. First, a standard shelf of books is about three feet wide, while the average book is about one-half inch wide. This means a device will need to scan 70 to 100 books at a time. Algorithms for doing so need to be very fast per tag.

This also means that each tag must be very low resolution. Most Android operating system smart phones capture video at 720p or 1080p, and at 720p, a three-eighths inch wide tag in a three foot wide field of view corresponds to 13.3 pixels. At the same time, the binary representation of the LC number requires about 100 bits.

Libraries desire the labels to be less than one inch in height, because larger labels would cover the title and author information on the spine of the book. As a result, the preferred labels are 11 bits wide and 24 bits high, but could be higher, such as 50 bits, if more data are desired. Of course, the size and other characteristics of the label are not critical, and could vary substantially as a person having ordinary skill will understand from the explanation herein. In order to successfully decode these labels from a frame of video, and augment video real-time, a robust method is required, particularly when the resolution of the video is almost the same as the resolution of the labels. Each box on the label is about the same size as a pixel in the video image.

The app reads the labels on a row of books, and uses visual augmentations to provide information to the user. If the books appear to be in the correct order, all book spines are indicated with a green checkmark or other positive indicator. If one or more books seem to be out of order, the app calculates the minimum number of steps needed to rearrange the books, and marks those that need to be re-shelved with an orange question mark or other negative indicator. Books that appear to be in the wrong part of the library are marked with a red X or other significant indicator. Of course, any indicator that provides information to the human user could be substituted for these indicators.

The invention's decoding algorithm is a multi-stage process, and is just one example of how the information on the spine of the book can be analyzed by the computer in the smartphone. Other algorithms and processes will become apparent to the person having ordinary skill from the explanation herein. In pre-processing, image contrast is adjusted so that the tag decoding algorithm can assume that the data it is provided uses the full black/white gamut. The app uses a context-sensitive contrast enhancement algorithm that is specially tailored for the library setting. For each column of the image the app calculates the maximum and minimum luminance, and then linearly rescales the luminance of all pixels in that column so that the minimum becomes 0 and the maximum becomes 255.

Column-wise processing makes sense in the library setting, because the labels are applied to the spines of books, which are often slightly rounded. This means that pixels in the same column of the image tend to have similar lighting properties, but lighting varies tremendously from left to right.

After contrast enhancement in pre-processing, the labels are located using standard techniques. Each preferred label has a black outer border, a white inner border, and inside of that is the data portion of the tag. The two borders facilitate easy detection of the tags, even in low resolution images.

Significant blurring occurs because image data are nearly the same resolution as the actual labels being read. The preferred algorithm for reading the label includes a first step of sampling the image, using linear interpolation, so that each pixel in the tag is represented by three blocks by three blocks in the new image. The number of blocks can be higher. This will usually be higher resolution than the original image. Next, pixels with a luminance less than a predetermined minimum, such as 85, are rounded down to black, and those with luminance greater than a predetermined maximum, such as 170, are rounded up to white. Any between the minimum and maximum are left unchanged.

Next, all pixels in the leftmost column, and in the bottom row, are set as white. Following that step, the following process is carried out working on each pixel one at a time. Starting in the lower left, and moving left-to-right, then up, for each pixel p, the four neighbors are considered (up, left, right, and down). Next, the number of light neighbors (those with luminance above 170) is set to “lt” and the number of dark neighbors (those with luminance below 85) is set to “dk”; and then for this pixel p, the threshold is:

threshold=127−16*dk+16*lt.

If the luminance of p is above the threshhold, the pixel is rounded to white. If not, the pixel is rounded to black. Finally, in each three by three square, a majority “vote” is taken to determine whether that bit of the label is white or black. Because the video image and the tag being decoded is roughly the same resolution, it is quite likely that a pixel from the tag will be split between four neighboring pixels in the frame of video. In some cases a tag might have a “checkerboard” appearance, but look almost perfectly gray to the camera, because each camera pixel is seeing half of a black square and half of a white square.

By surrounding the data with a white border, this ensures that there are at least some pixels in the sampled image that can be definitively rounded to white. It also means that, even in the checkerboard case, the image will not be perfectly gray. Any white pixels that exist on the border (or corners) of the data-bearing part of the tag are brighter than gray. This means that if a pixel in the frame of video is really gray, it must indicate a black pixel in the tag. By looking at the four neighbors of a pixel the system can determine whether a gray pixel is really a white pixel with black neighbors, or a black pixel with white neighbors.

The tag decoding process is not perfect, so some post-processing is preferred. Firstly, the tags use error-detecting codes, in order to quickly identify any failed tag read. This can be compensated for by taking advantage of the fact that many tags are being read at a time, and a significant percentage of them are read successfully. To do this, the app maintains a stored set of tags that were correctly read in previous frames of video, and are used to fill in any missing data. In each frame the app consults stored frames to learn if there are at least two tags scanned during the current frame that are also in the stored set. If so, these tags are used to create a linear function that maps points from the previous frame of video to their positions in the current frame. The positions of all tags in the stored set are updated to reflect where they ought to appear in the current frame of video. In this way, each frame of video adds more tags to the display until all have been successfully read. In case there is no overlap between the current set of tags and the stored set, which means the user has moved to a different shelf, the app clears the stored set.

With the present invention it is possible to read many tags, even when the source video resolution is very close to the original tag resolution. Moreover, this can be done at interactive frame rates on mobile devices. This uses a decoding algorithm inspired by error-diffusion techniques. Furthermore, it should be understood that the preferred method is not the only way to read or decode tags on book spines.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of determining whether each of a plurality of objects is in order relative to an adjacent one of the plurality of objects, where each of the plurality of objects has an exposed unique identifier, the method comprising:
(a) disposing a camera in close enough proximity to the plurality of objects for the camera to create an image of the unique identifiers on each of the plurality of objects;
(b) detecting optically and substantially simultaneously the unique identifiers on all of the plurality of objects;
(c) determining, based at least on the simultaneously and optically detected unique identifiers, whether any of the plurality of objects is out of order; and
(d) providing a human-perceptible indicator that at least one of the objects is out of order.

2. The method in accordance with claim 1, wherein the step of providing a human-perceptible indicator comprises displaying, on a screen that displays at least one image of the plurality of objects, augmented reality indicators, which indicators are visually-perceptible to humans, for at least any objects that are out of order

3. The method in accordance with claim 2, further comprising the step of recording at least some of the unique identifiers.

4. The method in accordance with claim 3, further comprising the step of transmitting data containing said at least some of the unique identifiers to a central computer.

5. The method in accordance with claim 1, wherein the process of detecting further comprises:
(a) sampling the image of the unique identifier on one of the plurality of objects, using linear interpolation, so that a pixel in the unique identifier is represented by a block in a new image having multiple squares;
(b) denoting any pixel of the image having a luminance less than a predetermined minimum as black, any pixel of the image having a luminance more than a predetermined maximum as white, and any pixel of the image having a luminance between the predetermined minimum and the predetermined maximum is left unchanged;
(c) all pixels in one corner of the image of the unique identifier are set as white, and a threshold luminance is determined for each neighboring pixel by setting the number of neighbors with luminance above the predetermined maximum “lt” and the number of neighbors with luminance below the predetermined minimum is set to “dk”; and then threshold=127−16*dk+16*lt, where if the luminance is above the threshhold, the pixel is considered white and if below, the pixel is considered black; and
(d) in each square, the number of white and black pixels is counted and that portion of that square is determined by the color that makes up most of the square.

6. A method of determining whether each of a plurality of books stacked on a bookshelf is in order relative to an adjacent book in the plurality of books, where each of the plurality of books has an exposed unique identifier on the binding thereof, the method comprising:
(a) disposing a camera in close enough proximity to the plurality of books for the camera to detect optically the unique identifiers on the bindings of the books;
(b) detecting optically and substantially simultaneously the unique identifiers on all of the plurality of books;
(c) determining, based at least on the simultaneously and optically detected unique identifiers, whether any of the books is out of order; and
(d) displaying, on a screen that displays at least one image of the plurality of books, augmented reality indicators, which indicators are visually-perceptible to humans, for at least any book that is out of order.

7. The method in accordance with claim 6, wherein each of the books is in a substantially vertical orientation, and is stacked adjacent other vertically oriented books with substantially all bindings of all books facing the same direction, and the step of disposing the camera further comprises disposing the camera with its lens facing the bindings of all books and its display screen facing the user.

8. The method in accordance with claim 7, wherein the step of displaying augmented reality indicators further comprises displaying such indicators on the screen of the camera.

9. The method in accordance with claim 8, wherein the camera further comprises a smartphone having a built in camera and a built in display screen.

10. An optical scanning and order indicating apparatus configured to detect whether a book is out of order relative to an adjacent book, where each of the books has an exposed unique identifier, the apparatus comprising:
(a) a camera configured to detect optically and substantially simultaneously the unique identifiers on the books and transmit data related thereto;
(b) an onboard computer connected to the camera for determining, based at least on the data transmitted from the camera to the computer, whether any of the books is out of order, the onboard computer generating augmented reality indicators for at least any book that is out of order; and
(c) a screen that displays at least the books and the augmented reality indicators, both of which are visually-perceptible to humans, to advise a human user which of the books is out of order.

11. The optical scanning and order indicating apparatus in accordance with claim 10, wherein the camera, onboard computer, and screen are structures of a portable device.

12. The optical scanning and order indicating apparatus in accordance with claim 11, wherein the portable device is a smartphone.

13. The optical scanning and order indicating apparatus in accordance with claim 12, further comprising a central computer to which the onboard computer connects wirelessly to transmit data related to the unique identifiers.

14. The optical scanning and order indicating apparatus in accordance with claim 13, wherein the central computer retains the data in a database inventory of the books.
